(19) United States
(12) Patent Application Publication
(10) Pub. No.: US 2005/0033913 A1
(43) Pub. Date: Feb. 10, 2005

(54) Method and system for controlling a robotic arm in a storage device

(76) Inventors: Rajiv Kottomtharayil, Ocean, NJ (US); Ho-Chi Chen, Marlboro, NJ (US)

Correspondence Address: BROWN, RAYSMAN, MILLSTEIN, FELDER & STEINER LLP, 900 THIRD AVENUE, NEW YORK, NY, 10022, US

(21) Appl. No.: 10/819,102

(22) Filed: Apr. 5, 2004

Related U.S. Application Data
(60) Provisional application No. 60/460,229, filed on Apr. 3, 2003.

(51) Int. Cl. G06F 12/00

(52) U.S. Cl. 711/114

(57) ABSTRACT

The invention relates generally to controlling access to a storage device. In a three-tier storage system including a storage manager, media management devices and storage devices, access to a storage device containing a robotic arm is dynamically assignable to one or more media management devices in accordance with user preferences, storage policies or other logical bases, such as network efficiency or availability. The invention also provides a computerized method for assigning control of a robotic arm to one or more media management devices.

### RELATED APPLICATIONS

This application claims priority to Provisional Application No. 60/460,229, filed Apr. 3, 2003 the entirety of which is hereby incorporated by reference.

This application is related to the following pending applications, each of which is hereby incorporated herein by reference in its entirety:
Application Ser. No. 60/460,234, titled METHOD AND SYSTEM FOR PERFORMING STORAGE OPERATIONS IN A STORAGE NETWORK, filed Apr. 3, 2003, attorney docket number 4982/35;
application Ser. No. 09/610,738, titled MODULAR BACKUP AND RETRIEVAL SYSTEM USED IN CONJUNCTION WITH A STORAGE AREA NETWORK, filed Jul. 6, 2000, attorney docket number 4982/8;
application Ser. No. 09/774,268, titled LOGICAL VIEW AND ACCESS TO PHYSICAL STORAGE IN MODULAR DATA AND STORAGE MANAGEMENT SYSTEM, filed Jan. 30, 2001, attorney docket number 4982/10;
application Ser. No. 60/409,183, titled DYNAMIC STORAGE DEVICE POOLING IN A COMPUTER SYSTEM, filed Sep. 9, 2002, attorney docket number 4982/18P;
application Ser. No. 10/260,209, titled SYSTEM AND METHOD FOR ARCHIVING OBJECTS IN AN INFORMATION STORE, filed Sep. 30, 2002, attorney docket number 4982/19; and
application Ser. No. 10/303,640, titled SELECTIVE DATA REPLICATION SYSTEM AND METHOD, filed Nov. 25, 2002, attorney docket number 4982/21.

### COPYRIGHT NOTICE

A portion of the disclosure of this patent document contains material which is subject to copyright protection. The copyright owner has no objection to the facsimile reproduction by anyone of the patent document or the patent disclosures, as it appears in the Patent and Trademark Office patent files or records, but otherwise reserves all copyright rights whatsoever.

### BACKGROUND OF THE INVENTION

The invention disclosed herein relates generally to data storage systems in computer networks and, more particularly, to improvements in allocating control of a robotic arm which provides access to, among other things, a storage device.

Storage architecture used by individual computers to store electronic data typically includes volatile storage media such as Random Access Memory (RAM), and one or more nonvolatile storage devices such as hard drives, tape drives, optical disks, and other storage devices that form a part of or are directly associated with an individual computer. A network of computers such as a Local Area Network (LAN) or a Wide Area Network (WAN), typically store electronic data via servers or stand-alone storage devices accessible via the network. Stand-alone storage devices can be connected to one individual computer or a network of computers. Examples of network storage devices include networkable tape drives, optical libraries, Redundant Arrays of Inexpensive Disks (RAID), CD-ROM jukeboxes, and other devices. Network storage devices commonly known in the art include drives accessing tapes or other storage media, and a robotic arm.

Each network storage device is generally controlled by a storage manager or computer, and is physically or virtually associated with the controlling storage manager or computer to perform backups, transaction processing, file sharing, and other storage-related applications. The association between a controlling storage manager or computer and storage device is static, and cannot be changed.

Similarly, in existing network storage architectures, the robotic arm within a storage device is controlled by a storage manager or a media management device. In current storage management systems, the relationship between a storage manager or media management device controlling the robotic arm is statically associated with each robotic arm. The storage manager or media management device controlling the robotic arm can be statically associated by a logical, virtual, or physical connection between a robotic arm and a storage manager or media management device. The static association between a robotic arm and a storage manager or media management device limits control of a robotic arm to only the associated storage manager or media management device, and control of the robotic arm cannot be changed to another storage manager or media management device. The robotic arm in a network storage device is generally used as an intermediary device between storage media and a drive. The robotic arm is used to fetch and replace tapes into drives used in storage operations.

Thus, only the storage manager or media management device to which a particular storage device is connected has control of that storage device. For example, the robotic arm within a storage device can only be controlled by the storage manager or media management device to which it is directly connected. Therefore, all storage operations from other storage managers or media management devices not associated with a robotic arm, must be sent via the network and through the associated controlling storage manager or media management device before it can be stored on the storage device connected to the associated controlling storage manager or media management device. This results in network inefficiencies that may be caused by congestion over network pathways leading between the controlling storage manager or media management device and the robotic arm, and the inability for a storage manager or media management device to communicate directly with a robotic arm associated with another storage manager or media management device.

In static storage architecture, when a controlling storage manager or media management device fails, the robotic arm cannot be controlled. Since control of the robotic arm cannot be changed, no other storage manager or media management device can control the robotic arm, and therefore the robotic arm cannot be controlled by any other component in the storage architecture. The inability to control a robotic arm means that the storage media contained in the storage device cannot be accessed, and therefore the storage operation will fail.

There is thus a need for a method and system which addresses a need to improve flexibility in managing and controlling the robotic arm in storage devices and the associated storage access issues.

### BRIEF SUMMARY OF THE INVENTION

The present invention addresses the issues discussed above, and includes a method for allocating control of a robotic arm to access a storage device accessible via a computerized network.

In one aspect of the invention, this is accomplished with a computer system for dynamically allocating control of a robotic arm in a storage device including at least one media management device communicatively coupled to at least one storage device having a robotic arm communicatively coupled to at least one storage manager. The storage manager is generally programmed to assign control of the robotic arm in the storage device to a first media management device associated with the storage device. Based upon selection logic, the storage manager selects a second media management device and assigns control of the robotic arm to the second media management device.

In one embodiment of the invention, the selection logic selects the second media management device in the event of a failure in the first media management device. In an alternate embodiment of the invention, the selection logic selects the second media management device according to availability of the second media management device. The availability of the second media management device is generally determined according to for example, proximity to the storage device, or efficient use of network resources.

In another embodiment of the invention, the selection logic selects the second media management device in accordance with user preferences, or according to storage policies.

The computer system for controlling a robotic arm in a storage device may also include storing in an index the identity of the first media management device and relationship of the first media management device to the robotic arm, or the second media management device and relationship of the second media management device to the robotic arm.

In another aspect of the invention, a computerized method is provided for dynamically allocating control of a robotic arm in a storage device. One embodiment of the method includes the steps of assigning control of a robotic arm associated with a storage device to a first media management device associated with the storage device; selecting, in accordance with selection logic, a second media management device associated with the storage device; and assigning, to the second media management device, control of the robotic arm associated with the storage device.

The selection logic used in the step of selecting a second media management device may include selecting the second media management device in the event of a failure in the first media management device. In another embodiment of the method, the selection logic is according to availability of the second media management device. Availability of the second media management device may be for example, according to proximity to the storage device, or efficient use of network resources.

In an alternate embodiment of the method, the selection logic is according to user preferences or storage policies.

The method of dynamically assigning control of a robotic arm in a storage device may also include the step of storing in an index the identity of the first media management device and relationship of the first media management device to the robotic arm, or the second media management device and relationship of the second media management device to the robotic arm in an index.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a block diagram showing a view of the network architecture and components of according to an embodiment of the invention;

FIG. 2 is a block diagram showing the storage device components according to an embodiment of the invention;

FIG. 3 is a flowchart presenting a procedure to select a media management device according to an embodiment of the invention;

FIG. 4 is a flowchart presenting a procedure for assigning control of the robotic arm according to an embodiment of the invention; and

FIG. 5 is a block diagram showing a view of prior art robotic arm control allocation and robotic arm control allocation according to an embodiment of the invention.

### DETAILED DESCRIPTION

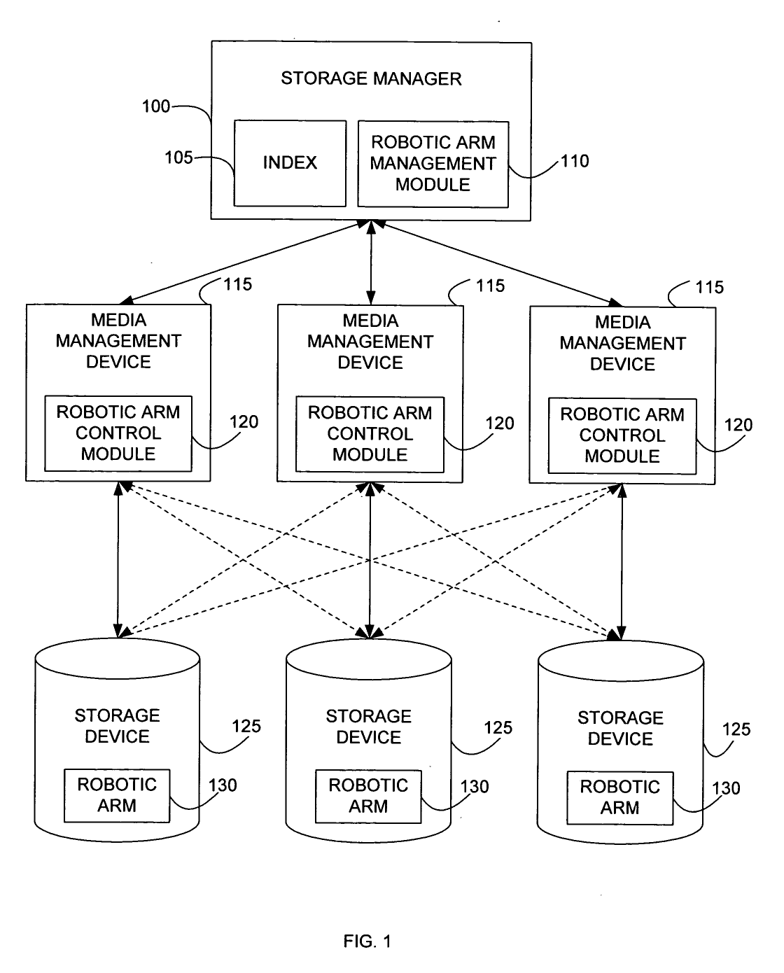

Preferred embodiments of the invention are now described with reference to the drawings. An embodiment of the system of the present invention is shown in FIG. 1. The system and components of the system as presented in FIG. 1 are exemplary of a three-tier backup system such as the CommVault Galaxy backup system, available from CommVault Systems, Inc. of Oceanport, N.J., and further described in application Ser. No. 09/610,738 which is incorporated herein by reference in its entirety.

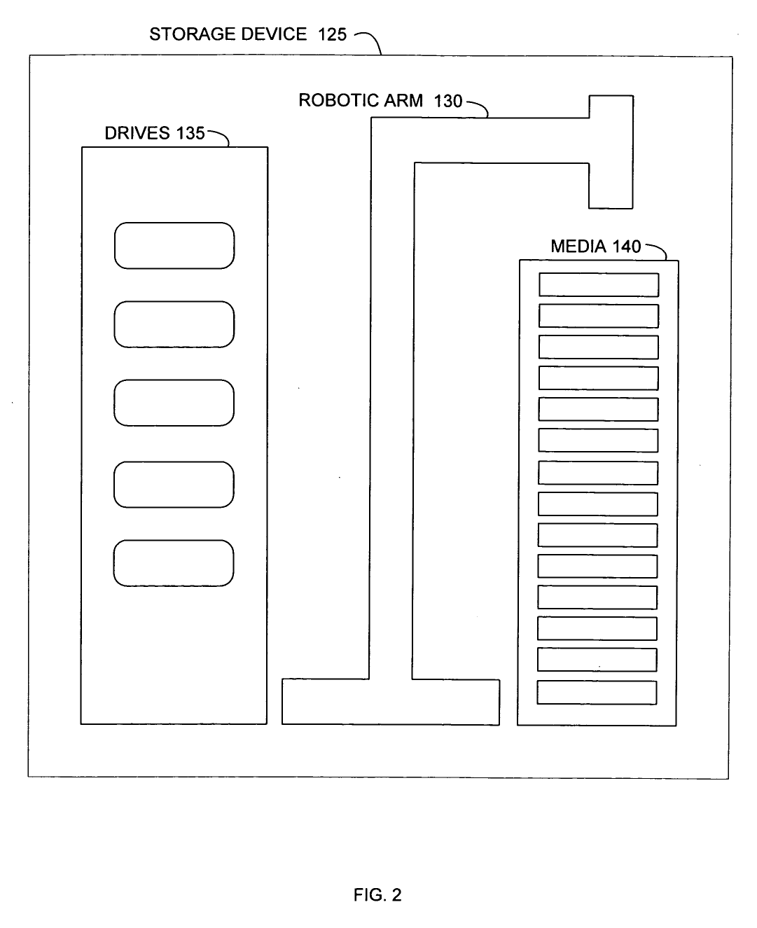

As shown in FIG. 1, the storage system includes a storage manager 100, which includes an index 105 and a robotic arm management module 110, media management devices 115, which include a robotic arm control module 120, and storage devices 125, which include a robotic arm 130. As shown in FIG. 2, the storage device 125 further includes drives 135 and media 140.

The storage manager 100 can be a software module, which is capable of coordinating and controlling a storage system. For example, the storage manager 100 communicates with all components of the storage system, including, for example, a media management device 115, to initiate, perform, and manage system backups, migrations, restores, and other storage-related operations.

The index 105 included in the storage manager 100 can be any storage index that is maintained to store index data for each system storage backup operation, such as, the data the system generates during backup, migration, restore, and other storage operations as further described herein. The index 105 can also can be a storage index known in the art, such as, for example, the index cache of CommVault's Galaxy™ as further described in application Ser. No. 10/260,209 which is incorporated herein by reference in its entirety. The index 105 stores data related to logical association controls, network pathways, and maintaining hierarchies in system components. For example, the index 105 stores data such as the relationships between a storage manager and components of the storage system and the relationships between the components of the storage system. In addition, the index 105 may store data defining communication pathways between the storage system components. Index data is useful because, among other benefits, it provides the system with an efficient mechanism for locating information associated with performing storage operations.

The storage manager 100 also contains a robotic arm management module 110. The robotic arm management module 110 is generally a software module capable of managing the functions or operations of a robotic arm. For example, in some embodiments, the robotic arm management module 110 controls intermediary devices associated with controlling a robotic arm, assigns control of the robotic arm to one or more media management devices 115, and performs other functions or operations necessary to obtain access to a storage device having a robotic arm. An example of existing storage devices having robotic arms include the Storage Technology Corporations StorageTek L20.

Each media management device 115 is associated with one or more storage devices 125 and controls the robotic arm 130 within the associated storage device 125 using a robotic arm control module 120. The association of a media management device 115 and a storage device 125 is established according to one or more logical selection procedures, such as: user preferences, a system storage policy, algorithms, for example, in accordance with network availability, or efficiency, or other logical selection procedure known in the art. For example, user preferences for associating a media management device 115 and a storage device 125 may be according to the user's preferences in accordance with availability, need, capacity, or other factors known in the art.

In another embodiment of the invention, a media management device 115 and a storage device 125 are associated according to a system storage policy which defines performance of storage operations over the system, for example, frequency and type of the storage operation to be performed. A storage policy presents the storage operation settings such that an individual user need not have knowledge or understanding of the storage architecture and technology. Storage policies are a logical concept relating one or more storage components that establish, for example, how a backup data set will be stored, and which components will perform the operation. Associations of media management devices 115 and storage devices 125 may be established in a system of the invention by one or more of the above-described means.

The media management devices 115 are connected physically or logically to the storage manager 100, for example, via a local connection or a network. Each of the media management devices 115 shown in FIG. 1 include a robotic arm control module 120. The robotic arm control module 120 is a module capable of controlling a robotic arm in a storage device by communicating and directing instructions directly to the robotic arm 130, or directly to the associated storage device 125, related to a storage operation.

Each media management device 115 is originally associated with a storage device 125, as shown by the solid lines between the media management devices 115 and storage devices 125. The association of the media management devices 115 and storage devices 125 is assigned by the storage manager 100, and data related to the association between the media management device 115 and storage device 125 is stored in the index 105. As further described herein, the association of media management devices 115 and storage devices 125 may be dynamically changed and reassigned between the system components, as shown by the dotted lines of FIG. 1 between the media management devices 115 and the storage devices 125. Data related to changes in the association and control of media management devices 115 and storage devices 125 is recorded in the index 105.

The media management device 115 is communicatively coupled to a storage manager 100 and a storage device 125. The media management device 115 is capable of communicating instructions from the storage manager 100 to a storage device 125 to undertake a storage operation. For example, the media management device 115 may instruct the storage device 125 to archive, migrate, restore stored data, or other storage operation. Such storage operation instructions are communicated by the robotic arm control module 120 controlling the robotic arm 130 of a storage device 125. The media management devices 115 may also conduct other data between the storage manager 100 and one or more storage devices 125. The media management device 115 generally communicates with the storage device 125 via a local bus such as a SCSI adapter. In some embodiments, the storage device 125 is communicatively coupled to the media management device 115 via a Storage Area Network (“SAN”).

The storage device 125 may be one or more devices, as defined herein. In one embodiment, as shown in FIG. 2, the storage device 125 includes a robotic arm 130, drives 135 and media 140. Each of the elements of the storage device 125 may be any appropriate device known in the art capable of performing a storage operation, for example, the media 140 can be tapes, media cartridges, or other media capable of storing data, such as HP DDS/DAT data cartridges. The drives 135 can be disk drives or other drives, such as HP Ultrium tape drives, capable of receiving media 140 and reading the stored data on media 140. The robotic arm 130 can be any arm capable of obtaining the media 140 and loading it into a drive 135 and correspondingly capable of ejecting the media 140 from the drive 135 and replacing the media 140 in a location in the storage device 125.

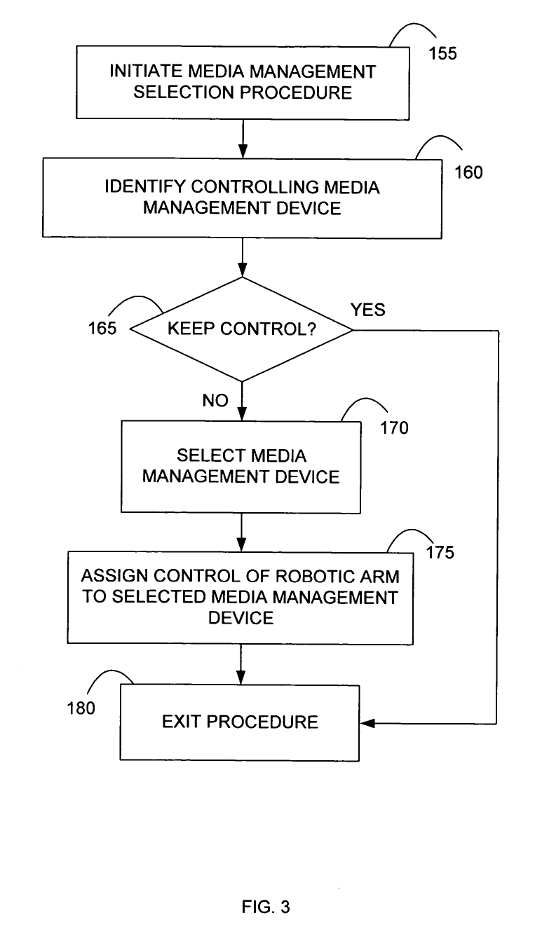

FIG. 3 is a flow diagram showing a method to assign control of a robotic arm 130 according to an embodiment of the invention. The storage manager 100 initiates a media management selection procedure, step 155, in connection with a storage operation, such as a backup, restore, or migration. Selection of a media management device may be initiated when, for example, the storage system is originally configured, at the commencement of each storage operation, when a media management device has failed or is otherwise unavailable, according to user preferences, or whenever the storage manager 100 determines that a media management device 115 should be selected to perform a storage operation.

The storage manager 100 identifies the controlling media management device 115, step 160, of the plurality of media management devices 115. The controlling media management device is generally the media management device 115 that is presently controlling the robotic arm 130, was previously controlling the robotic arm 130, or is otherwise associated with and/or controlling the robotic arm 130. For example, the storage manager 100 identifies the controlling media management device 115 by querying the index 105. As described above, a storage manager 100 or other component stores data related to the storage system component relationships, including data such as the identity of the media management device 115 controlling a robotic arm 130, in the index 105.

The storage manager 100 determines whether to keep control of the robotic arm 130 with the identified controlling media management device, or whether to assign control to another media management device 115, step 165. If the storage manager 100 keeps control of the robotic arm 130 with the identified media management device, the storage manager exits the procedure, step 180.

If the storage manager 100 does not keep control of the robotic arm 130 with the identified media management device 115, the storage manager 100 selects another media management device 115 to control the robotic arm 130, step 170. A media management device 115 is selected according to, for example, user preferences, a storage policy, or other factors. For example, a user may assign control of a robotic arm 130 to any particular media management device 115 according to the user's preference or needs. Alternatively, a system storage policy may assign a particular media management device 115 to the robotic arm 130 of a specific storage device 125 in established storage system settings, which may be set according to, for example, availability or network efficiency. In addition, the storage manager 100 may select the media management device 115, using a logical selection process, for example, by examining the network pathways and selecting a media management device 115 according to one or more algorithms or logical bases, such as proximity, efficient use of resources, or availability. The logical selection processes, for example, may include examination of the network and logical pathways to determine for example, which storage device 125 would provide a most efficient use of the network system resources.

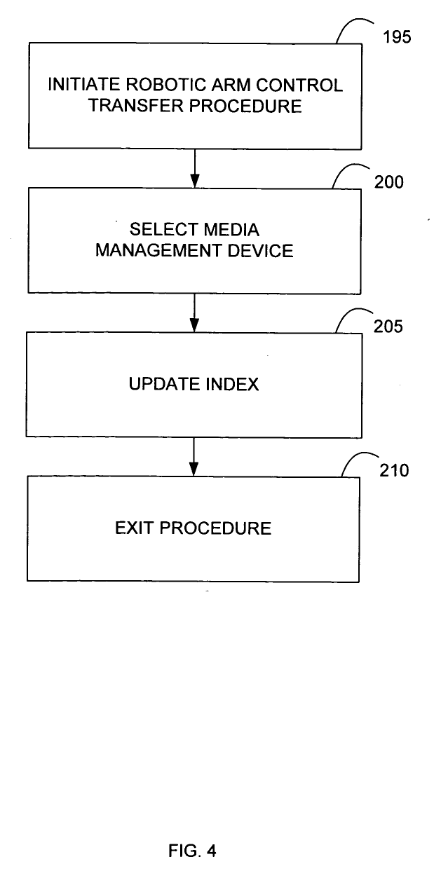

When a media management device 115 is selected, the storage manager 100 assigns control of the robotic arm 130 to the selected media management device, step 175. A flowchart of the procedure for assigning control of the robotic arm 130 to selected media management device is presented in FIG. 4. Control of the robotic arm 130 is assigned, and the storage manager exits the procedure, step 180.

FIG. 4 is a flow diagram of a method to dynamically allocate control of the robotic arm according to an embodiment of the invention. The storage manager 100 initiates a robotic arm control transfer procedure, step 195. In step 200, a media management device 115 is selected and the selected media management device is assigned control of a robotic arm 130. The storage manager 100 directs the selected media management device to assume an active state with respect to control of the robotic arm 130. The information, data, and identifying characteristics related to transferring control of the robotic arm to a second media management device is updated and recorded in the index 105, step 205.

The index 105, as discussed previously, contains data relating to system hierarchies and relationships between storage components within the system. The method to dynamically allocate control of the robotic arm 130, involves querying the index 105 to provide information about the storage system, for example, availability of media management devices 115, network availability, other component availability, or efficient of use of system resources.

The content of the information updated in the index, is related to the transfer of control of the robotic arm 130 to a second media management device. The information updated in the index, includes for example, information such as the pathway between a media management device 115 and a storage device 125, and link information to a data item's storage location. The index information is used by the storage manager 100, for example, to provide information to set the network pathway to reassign control of the robotic arm 130. An example of such link information is a Universal Naming Convention (“UNC”), or other naming convention, or path to the item's index entry in a Galaxy file system. The storage manager exits the procedure, step 210.

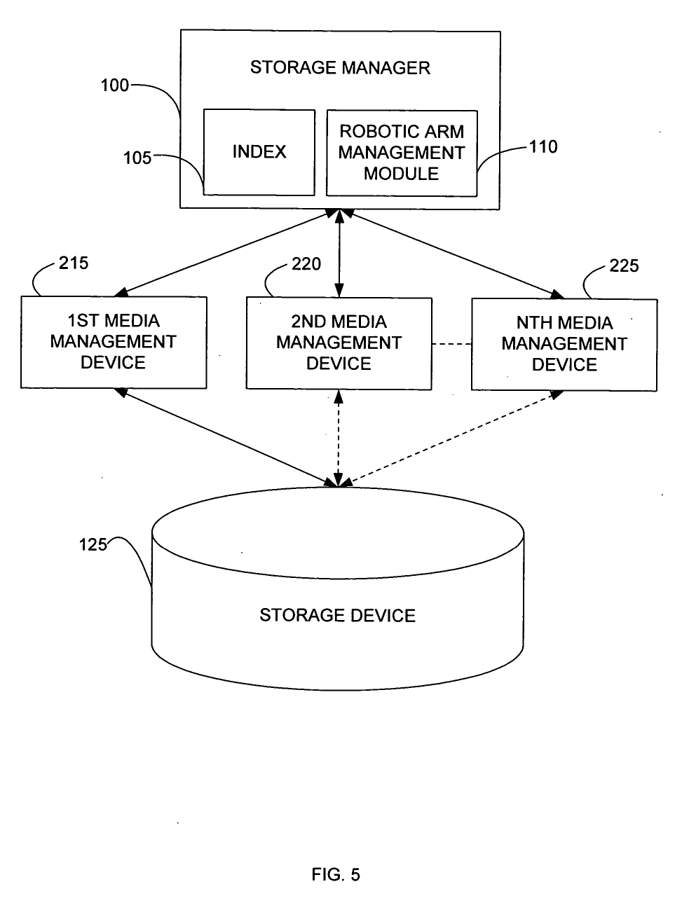

FIG. 5 presents a block diagram showing the static association and relationship of components in prior art storage systems, as previously described. In prior art storage systems, the control of a robotic arm within a storage device is statically assigned to one particular storage manager or media management device. The static association, of the prior art, between the devices is shown by the solid lines connecting a first media management device 215 to storage device 125. In storage systems in prior art, if the second media management device 220 or the Nth media management device 225 sought access to the storage device 125, the second and Nth media management devices 220 and 225 would be routed through the storage manager 100. The storage manager 100 would communicate with the first media management device 215, which would access the storage device 125 by controlling the robotic arm 130 within the storage device 125, on behalf of the second media management device 220 or the Nth media management device 225. In the event that the first media management device 215 failed, the robotic arm 130 within the storage device 125 cannot be controlled, and therefore the data stored in the storage device 125 cannot be reached.

In a scenario where a first media management device 215 failed, the system of the present invention, provides a failover solution. The present invention dynamically reassigns control of the robotic arm 130 within the storage device 125 from the failed or otherwise unavailable media management device 215 to an alternate media management device, such as the second or Nth media management devices 220 or 225 thereby allowing direct control of the robotic arm 130 within storage device 125. The dynamic assignment of control is shown as the dotted lines of FIG. 5 between the second or Nth media management devices 220 and 225 and the storage device 125. The present invention provides the storage system with the capability of maximizing the efficient use of system and network resources by identifying failures, and reallocating control of devices according to availability. The implications of providing dynamic allocation of control of a robotic arm, as presented here include, among other advantages, the ability for storage operations to be performed directly by each media management device, without relying upon a first media management device 215, which may be unavailable. The capability to dynamically allocate control of a robotic arm among the media management devices provides independence of each system component, which maximizes the efficient use of system resources.

Systems and modules described herein may comprise software, firmware, hardware, or any combination(s) of software, firmware, or hardware suitable for the purposes described herein. Software and other modules may reside on servers, workstations, personal computers, computerized tablets, PDAs, and other devices suitable for the purposes described herein. Software and other modules may be accessible via local memory, via a network, via a browser or other application in an ASP context, or via other means suitable for the purposes described herein. Data structures described herein may comprise computer files, variables, programming arrays, programming structures, or any electronic information storage schemes or methods, or any combinations thereof, suitable for the purposes described herein.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1. A computerized method for allocating control of a robotic arm in a storage device, the method comprising:
assigning control of a robotic arm associated with a storage device to a first media management device associated with the storage device;
selecting, in accordance with selection logic, a second media management device associated with the storage device; and
transferring, from the first media management device to the second media management device, control of the robotic arm associated with the storage device.

2. The method of claim 1 wherein selecting, in accordance with selection logic, comprises selecting the second media management device in the event of a failure of the first media management device.

3. The method of claim 1 wherein selecting, in accordance with selection logic, comprises selecting the second media management device in accordance with availability of the second media management device.

4. The method of claim 1 wherein selecting, in accordance with selection logic, comprises selecting the second media management device in accordance with proximity of a network pathway between the second media management device and the storage device.

5. The method of claim 1 wherein selecting, in accordance with selection logic, comprises selecting the second media management device in accordance with efficiency in the network pathway between the second media management device and the storage device.

6. The method of claim 1 wherein selecting, in accordance with selection logic, comprises selecting the second media management device in accordance with a user preference.

7. The method of claim 1 wherein selecting, in accordance with selection logic, comprises selecting the second media management device in accordance with a storage policy.

8. The method of claim 1 comprising storing, in an index, data related to the assignment of control of the robotic arm to the first media management device.

9. The method of claim 1 comprising storing, in an index, data related to the transfer of control of the robotic arm from the first media management device to the second media management device.

10. A computer system for allocating control of a robotic arm in a storage device, the system comprising:
a storage device having a robotic arm communicatively coupled to a first media management device; and
at least one storage manager coupled to the first media management device, wherein the at least one storage manager is programmed to:
assign control of the robotic arm to the first media management device coupled to the storage device;
select, in accordance with selection logic, a second media management device coupled to the storage device; and
transfer control of the robotic arm from the first media management device to the second media management device.

11. The system of claim 10 wherein the storage manager selects the second media management device in the event of a failure of the first media management device.

12. The system of claim 10 wherein the storage manager selects the second media management device in accordance with the availability of the second media management device.

13. The system of claim 10 wherein the storage manager selects the second media management device in accordance with proximity of a network pathway between the second media management device and the storage device.

14. The system of claim 10 wherein the storage manager selects the second management device in accordance with efficiency in the network pathway between the second media management device and the storage device.

15. The system of claim 10 wherein the storage manager selects the second management device in accordance with a user preference.

16. The system of claim 10 wherein the storage manager selects the second management device in accordance with a storage policy.

17. The system of claim 10 comprising at least one index communicatively coupled to the storage manager, and programmed to store data related to the assignment of control of the robotic arm to the first media management device.

18. The system of claim 17 wherein the at least one index is programmed to store data related to the transfer of control of the robotic arm from the first media management device to the second media management device.

19. A method for controlling a robotic arm in a storage device, the method comprising:
identifying a first media management device which controls a robotic arm associated with a storage device;
determining that the first media management device should not maintain control of the robotic arm associated with the storage device;
selecting, in accordance with selection logic, a second media management device to control the robotic arm associated with the storage device; and
transferring control of the robotic arm associated with the storage device from the first media management device to the second media management device.

20. The method of claim 19 wherein identifying a first media management device which controls a robotic arm associated with a storage device comprises querying an index.

21. The method of claim 19 wherein determining that the first media management device should not maintain control of the robotic arm associated with the storage device comprises using a storage manager to determine that the first media management device should not maintain control of the robotic arm associated with the storage device.

22. The method of claim 19 wherein determining that the first media management device should not maintain control of the robotic arm associated with the storage device comprises determining that the first media management device has failed.

23. The method of claim 19 wherein selecting, in accordance with selection logic, comprises selecting the second media management device in accordance with the availability of the second media management device.

24. The method of claim 19 wherein selecting, in accordance with selection logic, comprises selecting the second management device in accordance with proximity of a network pathway between the second media management device and the storage device.

25. The method of claim 19 wherein selecting, in accordance with selection logic, comprises selecting the second management device in accordance with efficiency in a network pathway between the second media management device and the storage device.

26. The method of claim 19 wherein selecting, in accordance with selection logic, comprises selecting the second media management device in accordance with a user preference.

27. The method of claim 19 wherein selecting, in accordance with selection logic, comprises selecting the second media management device in accordance with a storage policy.

28. The method of claim 19 comprising storing, in an index, data related to the assignment of control of the robotic arm to the first media management device.

29. The method of claim 19 comprising storing, in an index, data related to the transfer of control of the robotic arm from the first media management device to the second media management device.

30. A computer system for controlling a robotic arm in a storage device, the system comprising:
a first media management device communicatively coupled to a storage device having a robotic arm; and
at least one storage manager communicatively coupled to the first media management device, the at least one storage manager programmed to:
identify the first media management device which controls the robotic arm;
determine that the first media management device should not maintain control of the robotic arm;
select, in accordance with selection logic, a second media management device to control the robotic arm; and
transfer control of the robotic arm from the first media management device to the second media management device.

31. The system of claim 30 wherein the at least one storage manager is programmed to determine that the first media management device should not maintain control of the robotic arm if the a least one storage manager determines the first media management device has failed.

32. The system of claim 30 wherein the at least one storage manager is programmed to select, in accordance with selection logic, a second media management device to control the robotic arm in accordance with availability of the second media management device.

33. The system of claim 30 wherein the at least one storage manager is programmed to select, in accordance with selection logic, a second media management device to control the robotic arm in accordance with proximity of a network pathway between the second media management device and the storage device.

34. The system of claim 30 wherein the at least one storage manager is programmed to select, in accordance with selection logic, a second media management device to control the robotic arm in accordance with efficiency of a network pathway between the second media management device and the storage device.

35. The system of claim 30 wherein the at least one storage manager is programmed to select, in accordance with selection logic, a second media management device to control the robotic arm in accordance with a user preference.

36. The system of claim 30 wherein the at least one storage manager is programmed to select, in accordance with selection logic, a second media management device to control the robotic arm in accordance with a storage policy.

37. The system of claim 30 comprising at least one index communicatively coupled to the storage manager and programmed to store data related to an assignment of control of the robotic arm to the first media management device.

38. The system of claim 37 wherein the at least one index is programmed to store data related to the transfer of control of the robotic arm from the first media management device to the second media management device.

39. The system of claim 37 wherein the at least one index is used to identify the first media management device which controls the robotic arm.
